(19) United States
(12) Patent Application Publication
(10) Pub. No.: US 2003/0127762 A1
(43) Pub. Date: Jul. 10, 2003

(54) Precise mold controlling method for injection molding of plastic

(76) Inventor: Chih Chen Huang, Taipei (TW)

Correspondence Address: David E. Dougherty, DENNISON, SCHULTZ & DOUGHERTY, 612 Crystal Square 4, 1745 Jefferson Davis Highway, Arlington, VA, 22202, US

(21) Appl. No.: 10/035,317

(22) Filed: Jan. 4, 2002

(51) Int. Cl. B29C 45/76; B29C 45/78

(52) U.S. Cl. 264/40.1; 264/40.6

(57) ABSTRACT

A precise mold controlling method for injection molding of plastic, wherein, a detecting device is connected to the interior of a die set to practice controlling interiorly of the die set, a temperature sensor is connected with a reduced feeding opening of a high speed injection shaping machine, the temperature “t” during injection of plastic by the high speed injection shaping machine can be detected by a temperature sensor, in cooperation with the fullness of filling measured in the die set by the detecting device and the pressure “p” required for feeding decided by the digital control device controlling an oil pressure feeding device of the high speed injection shaping machine to forward and return material in time, the density “v” of plastic in the die set can keep a predetermined value, thus a housing with a precise size can be produced.

### BACKGROUND OF THE INVENTION

1. Field of the Invention

The present invention is related to a precise mold controlling method for injection molding of plastic in manufacturing products of high precision such as carrying boxes of semiconductor elements and of electroluminescent elements etc., and especially to a precise mold controlling method for which in addition to have a pusher rod and an oil pressure device on a press closing die set to exert pressure on a male and a female die for injection molding a vacuum pumping device, a detecting device, a temperature sensor and a digital control device etc. are added to manufacture housings of high precision, this further elevate superiority of the products and increase the industrial value of the products.

2. Description of the Prior Art

Conventional plastic injection molding processes each has the plastic granules molten into fluid through high temperature, and has a press closing die set closed, has the fluid of plastic under high pressure injected into the die set and chilled to fix its shape after being molded and shaped.

Such conventional injection molding processes as stated are suitable for manufacturing housings of articles with ordinary precision (tolerance values of them are larger). Common daily necessities generally can be made by such conventional injection molding processes. However, for the newborn industry of semiconductor or those related industries of high techniques, such conventional processes are deficient. It is because that common articles are not in need of housings of severely required tightness of closing; while semiconductor elements (such as wafers, electroluminescent elements etc.) in the industries of high techniques require storing environment of being dustless, no humid and even no oxygen. Sole application of such a conventional injection molding process is unable to get precision in shaping with high rate of superiority; the factors outside such as temperature, ununiformity of plastic etc. tend to change the ratio of contraction to expansion of products and the products resulted tend to have inferior closeness. Therefore, as to those industries of high techniques highly in need of housings with precision, such conventional injection molding processes are insufficient to overcome the technical problems resided.

In view that precision of housings of articles obtained by press closing die sets in conventional injection molding and shaping processes largely influence the quality of semiconductor elements, and the conventional injection molding and shaping processes has the above stated defects; the inventor studies and develops the present invention which can over come these defects.

### SUMMARY OF THE INVENTION

The primary object of the present invention is to provide a precise mold controlling method for injection molding of plastic to effectively manufacture products with sizes of high precision.

The secondary object of the present invention is to provide a precise mold controlling method for injection molding of plastic, which method can control density of the plastic being injected to thereby make certain of its ratio of contraction to expansion in order to avoid error of size.

To achieve the above stated objects, the present invention is comprised at least of: a closable die set, a detecting device, a temperature sensor and a digital control device.

Wherein, the detecting device is connected to an inner chamber of the die set and is controlled in the die set. The temperature sensor is provided at a reduced feeding opening of a high speed injection shaping machine; the high speed injection shaping machine can detect the temperature of the plastic being injected, thereby, the digital control device can decide the amount of pressure for injection to thereby increase the uniformity of the plastic material being injected. In cooperation synchronically with the fullness of filling measured in the die set by the detecting device, the digital control device can control an oil pressure feeding device of the injection shaping machine to return material in time, so that the density of plastic in the die set can keep a predetermined value, thus a housing with an identical ratio of contraction to expansion and precise size can be produced.

The present invention will be apparent in its particular structural, principle of application, functions and effects after reading the detailed description of the preferred embodiment thereof in reference to the accompanying drawings.

### BRIEF DESCRIPTION OF THE DRAWINGS

FIG. 1 is an analytical perspective view of a carrying box of the present invention;

FIG. 2 is a process flow sheet of the present invention;

FIG. 3 is a sectional schematic view of an injection shaping machine of the present invention.

### DETAILED DESCRIPTION OF THE PREFERRED EMBODIMENT

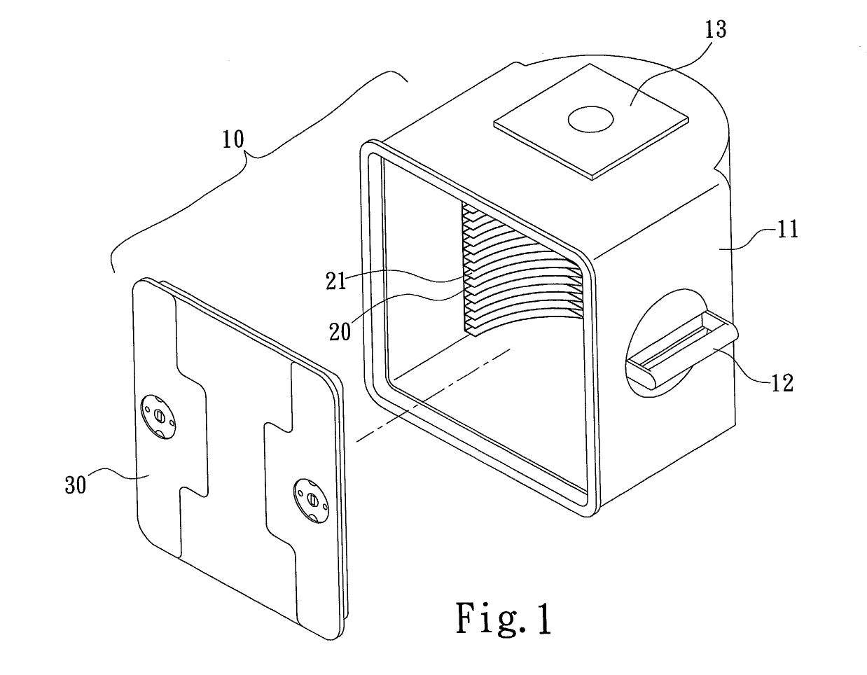

Referring firstly to FIG. 1, it shows a carrying box 10 of an organic electroluminescent (OEL) element of the present invention which has mainly a housing 11 with a tightly closable door 30, the housing 11 has handles 12 on the lateral sides thereof, and has on the top thereof a protrusion 13 to be raised by a mechanical arm. The housing 11 is provided therein with a plurality of mutually parallel units 20 forming a rack; the units 20 form in the rack a plurality of mutually parallel recesses 21. The units 20 are mounted at suitable positions for stably mount the OEL element in the recesses 21. The tightly closable door 30 can be tightly closed against the housing 11 to complete the carrying box 10 for storing the OEL element.

However, by virtue that the OEL element is subjected to creating a problem of oxidization in water or in oxygen, it is extraordinary important to make environmental control in the carrying box 10, generally the problem is dealt with by vacuum. The OEL element requires a tightly sealed space; requirement for the precision as well as quality of the housing 11 and the tightly closable door 30 when they are closed tight is relatively increased. The precision shall not change when the environment changes, while conventional injection molding processes are unable to control the ratio of contraction to expansion and precision of the carrying box 10 made, and the product resulted tends to be inferior. The point of the present invention thereby is to solve the problem of precision of the carrying box 10.

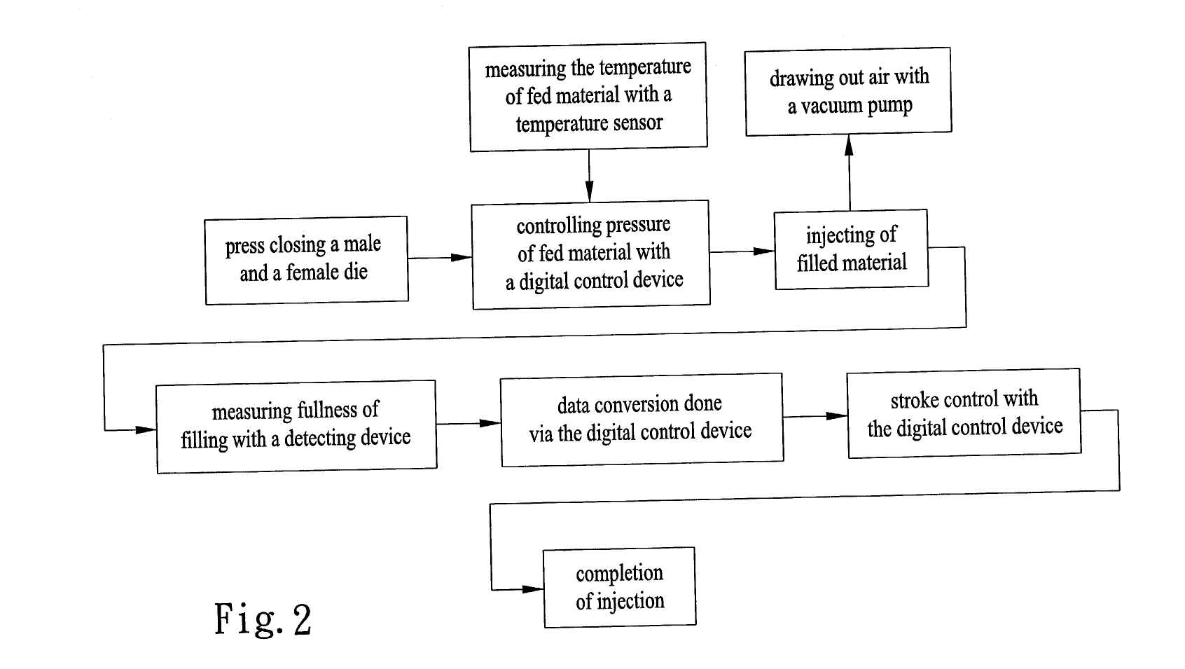

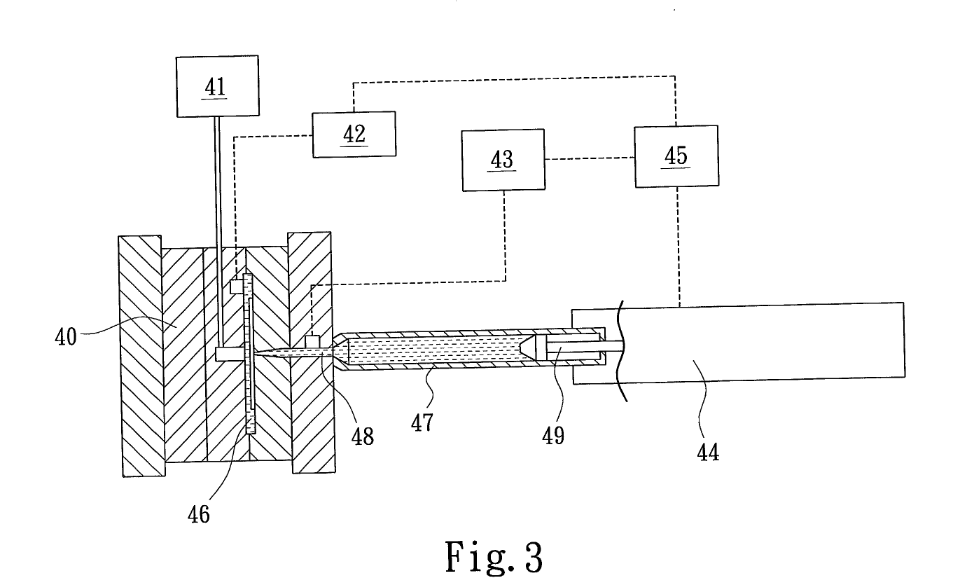

Referring to FIGS. 2 and 3, the device of the present invention is comprised of a closable die set 40, a vacuum pumping device 41, a detecting device 42, a temperature sensor 43, a high speed injection shaping machine 44 and a digital control device 45.

The closable die set 40 includes a male and a female die capable of automatically press closing to each other, a chamber 46 is formed by the male and the female dies, the vacuum pumping device 41 is connected to a specific position in the chamber 46 of the die set 40, so that the plastic injected will not mixed with the air in the chamber 46 to form air bubbles. And the detecting device 42 is controlled and connected in the chamber 46 of the die set 40. The high speed injection shaping machine 44 has an oil pressure feeding device 47, a reduced feeding opening 48 on the front end thereof is connected with the die set 40. The temperature sensor 43 is mounted and connected in the reduced feeding opening 48. The detecting device 42 and the temperature sensor 43 are communicated with the digital control device 45 which can be controlled and driven through a preset program (such as controlled by PID) to render the injection shaping machine 44 to do the functions of plastic temperature control, timing, feeding and material returning.

The method of manufacturing includes the following steps:

1. to connect the vacuum pumping device 41 to the article shaping area of the die set 40;

2. to connect the detecting device 42 to the interior of the die set 40 to practice controlling interiorly of the die set 40 and to detect the fullness of filling at the article shaping area of the die set 40;

3. to connect the temperature sensor 43 with the reduced feeding opening 48 of the high speed injection shaping machine 44 to detect the temperature of the plastic entering the die set 40;

4. to connect the digital control device 45 with the oil pressure feeding device 47 of the high speed injection shaping machine 44, and to connect the detecting device 42 and the temperature sensor 43 with the digital control device 45;

5. to perform feeding and pressing of the high speed injection shaping operation, and to synchronically activate the vacuum pumping device 41 to draw out the air in the die set 40 according to the value of temperature “t” measured by the temperature sensor 43 at the reduced feeding opening 48 and the pressure “p” required for feeding decided by the digital control device 45;

6. to detect the fullness of filling of pressed fed material by the detecting device 42 (can be a value of pressure or temperature), after antecedent distinguishment of the digital control device 45, the signal presenting the particular result of distinguishment further controls the oil pressure feeding device 47 of the high speed injection shaping machine 44 to retract it in the contrary direction, or to further forward to supplement material, to control the density “v” of plastic in the chamber.

Therefore, when the injection shaping machine 44 activates the oil pressure feeding device 47, the temperature during injection of plastic can be detected by the temperature sensor 43 at the reduced feeding opening 48 to control the feeding temperature, and to avoid change of density of the plastic following changing of the environment outside. And the temperature detected can be used to micro-adjust the oil pressure of the oil pressure feeding device 47 to avoid influencing fluidity of the plastic by changing of temperature which in turn makes ununiform of the plastic injected.

When a pusher rod 49 helps to pour the molten plastic into the die set 40 through the reduced feeding opening 48, an impact force of super high pressure is injected into the die set 40 to synchronically activate the vacuum pumping device 41 to draw out the air from the die set 40 in the tightly closed chamber 46, this can prevent generation of back pressure and air bubbles under the impact of the high speed injection. Thereby, no stress will remain in the housing, and thereby uniformity of distribution of the plastic injected can be relatively increased. However, the vacuum pumping device 41 can also be substituted by air holes provided in the die set 40 depending on requirement to avoid creating air bubbles.

When the plastic material enters the die set 40, in order to assure that the plastic can have enough time and speed to enter every corner in the die set 40, the digital control device 45 is used to control the oil pressure feeding device 47 to endue filling of the plastic with a preset pressure in the die set 40 within a short time.

Synchronically, the detecting device 42 provided in the die set 40 detects the value of pressure and temperature as a reference of fullness of filling of the plastic material. When an overly large pressure is detected, the digital control device 45 is used to control the oil pressure feeding device 47 to make the pusher rod 49 to fast retract and return material, thereby, the normal pressure in the die set 40 can be kept for a predetermined time which has been accurately calculated. Further by detecting the temperature in the die set 40, the digital control device 45 calculates the deformation amount of the die set 40 to micro-adjust the pusher rod 49 to feed or to return material without changing the volume of the chamber 46 formed in the die set 40 due to changing of the temperature outside. So that density of the plastic each time in the die set 40 can be fixed, and the character of uniformity of distribution of the plastic can be obtained, thereby, its ratio of contraction to expansion can be certain, and precision of products can be increased, and the plastic will have no over pressing or over expansion in the die set 40. Thereby, the die set 40 can be effectively protected to increase its life of use. The value of pressure and temperature in the chamber 46 of the die set 40 of the present invention is controlled under precise calculation, and thereby the present invention can injection shape products of larger precision.

The present controlling method can fix the density “v” of the plastic injected into the die set 40 by setting the parameters of pressure “p” and temperature “t”, the returned material can be used in the secondary injection without changing precision, and can be used for the plastic materials with different temperatures or used for specific surface combining of composite materials.

In conclusion, the products made by the present invention is detected on fullness of filling in the die set to make a control of supplementation or drawing out of material as well as of the temperature of the plastic being injected, to thereby adjust the pressure in the oil pressure feeding device to make equal density of the plastic being injected into the die set; and by control of PVT, products of high precision with same ratio of contraction to expansion can be made. The products meet the effect of economy as well as practicality, and the defects resided in the conventional methods can be gotten rid of.

My invention may assume numerous forms and is to be construed as including all modifications and variations falling within the scope of the appended claims.

What is claimed is:

1. A precise mold controlling method for injection molding of plastic, said method includes using: a closable die set, a detecting device, a temperature sensor and a digital control device; said method is characterized by comprising the following steps:
a. to connect said detecting device to the interior of said die set to practice controlling interiorly of said die set and for detecting fullness of filling of material at an article shaping area of said die set;
b. to connect said temperature sensor with a reduced feeding opening of a high speed injection shaping machine to detect temperature of the plastic entering said die set;
c. to connect said digital control device with an oil pressure feeding device of said high speed injection shaping machine, and to connect said detecting device and said temperature sensor with said digital control device;
d. to perform feeding and pressing of high speed injection shaping operation, and the pressure required for feeding is decided by said digital control device according to the value of temperature measured by said temperature sensor at said reduced feeding opening;
e. to detect fullness of filling of pressed fed plastic material by said detecting device in said die set, after antecedent distinguishment of said digital control device, a signal presenting the particular result of distinguishment further controls said oil pressure feeding device of said high speed injection shaping machine to retract it in a contrary direction, or to further forward to supplement plastic material, to control density of plastic in a chamber of said die set.

2. A precise mold controlling method for injection molding of plastic as in claim 1, wherein, said temperature sensor is provided at said reduced feeding opening.

3. A precise mold controlling method for injection molding of plastic as in claim 1, wherein, said detecting device is provided in said die set.

4. A detecting device as in claim 3, said detecting device has the ability to measure pressure, temperature etc. as references for fullness of filling of said plastic material in said die set.

5. A precise mold controlling method for injection molding of plastic as in claim 1, wherein, said die set is provided with a vacuum pumping device or air holes for exhausting air in said die set to avoid creating back pressure and air bubbles.
